(19) United States
(12) Patent Application Publication
(10) Pub. No.: US 2002/0093245 A1
(43) Pub. Date: Jul. 18, 2002

(54) Trailer braking systems

(76) Inventor: Michael Clarence Claerhout, Hamilton (NZ)

Correspondence Address: MASON, MASON & ALBRIGHT, 2306 South Eads Street, P.O Box 2246, Arlington, VA, 22202, US

(21) Appl. No.: 10/025,558

(22) Filed: Dec. 26, 2001

Related U.S. Application Data
(63) Continuation of application No. PCT/NZ00/00110, filed on Jun. 23, 2000.

(30) Foreign Application Priority Data
Jun. 24, 1999 (NZ) 336471

(51) Int. Cl. B60T 7/20

(52) U.S. Cl. 303/123

(57) ABSTRACT

A system for effecting a braking force on a towed vehicle, the system including at least one braking sensor located on a towing vehicle, a control unit for communication with a braking actuator mechanism located on the apparatus towed by the towing vehicle, the system characterized in that the control unit can determine braking force sensed by the braking sensor and signal braking actuator mechanism to apply a braking force to a towed vehicle proportional to the force applied to the braking sensor as determined by the control unit.

### TECHNICAL FIELD

This invention relates to improvements to trailer braking systems.

More specifically, the present invention relates to improvements to trailer braking systems that co-relate the braking of the towing vehicle to the braking on the trailer.

### BACKGROUND ART

For safety reasons, it is advantageous to have a braking system on a towed apparatus such as a trailer.

Mechanical and electrical towed vehicle braking systems are known.

One such device utilises the force of the towed apparatus against the towing vehicle when the towing vehicle decelerates. This force is converted mechanically to a braking force on the towing vehicle.

With this arrangement, there is a poor coloration between the braking force applied to the towing vehicle as opposed to the braking force applied to the towed apparatus.

Another system, described in U.S. Pat. No. 5,382,085, to Zbinden consists of an electrohydraulic or electropneumatic braking control device for the axles of trailers having mechanical brakes. A force proportional to the displacement of the brake pedal on the towing vehicle is said to be applied to the trailer brakes.

However, the braking force sensed on the towing vehicle is dependent on the distance that the braking pedal moves. Therefore, the braking force readings sensed are potentially erroneous.

Variations from vehicle to vehicle in pedal-free play may mean the braking force sensed at the pedal may not correspond accurately to the braking force applied to the towing vehicle. Further, known trailer braking systems are deficient in terms of electrical monitoring of the braking system, controlling unwanted movement of the trailer, and accommodating various trailer sizes and weights.

Further, in some jurisdictions, traffic regulations require trailers over a specific weight to have satisfactory braking systems installed.

Another problem with prior art braking systems is that these can be difficult to retrofit to existing cars or towing vehicle.

For example, systems that use the deplacement of the brake pedal often require conversion of existing hydraulics and electrics in the towing vehicle. This is time consuming, expensive, and can cause considerable problems in obtaining safety certification for the modified vehicle.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a system for effecting a braking force on a towed vehicle, the system including:

at least one braking sensor located on a towing vehicle,

a control unit for communication with a braking actuator mechanism located on the apparatus towed by the towing vehicle,

the system characterised in that

the control unit can determine the braking force sensed by the braking sensor and signals a braking actuator mechanism to apply a braking force to a towed vehicle proportional to the force applied to the braking sensor, as determined by the control unit.

The term vehicles should therefore not be seen to be limiting.

Reference to a towing vehicle may include any vehicle or plurality of vehicles, capable of towing another apparatus.

Reference to a towed vehicle may be made with reference to any applications that requires towing, whether it is capable of it's own powered motion or not.

Reference to the braking actuator mechanism on the towed vehicle may include electronic and mechanical mechanisms necessary to effect the braking force on the towed vehicle. For example, this may include further electronic, hydraulic, pneumatic equipment.

The braking actuator mechanism may include any one or all of a compressor, an accumulator housing, pneumatic valving, service brake piston assembly, and a park brake assembly.

The park brake assembly may either be in a mechanical or hydraulic form.

The braking sensor may be a device that senses the braking force applied to the braking mechanisnm of the towing vehicle.

In situations where the braking is effected by depressing a pedal on the towing vehicle, the braking force sensor may be located on the brake pedal pad.

Preferably, the braking sensor may sense the force exerted directly on the braking pedal of the towing vehicle.

The force sensor may come in a number of forms. The force sensor may be a typical strain gauge, a fluid filled bladder or perhaps a spring loaded transducer.

In preferred embodiments the force sensor is a piezo-sensitive laminate.

With the use of a piezo-sensitive laminate, there is a number of advantages in the implementation of the present invention. Laminate is by nature thin, being only a fraction of a millimeter thick. This means that the laminate can be placed on or in the near vicinity of the brake pedal without effecting a noticeable physical change to the brake pedal. That is, the driver of the vehicle would not notice the inclusion of the laminate when operating the brake.

Another advantage of using laminate is that it has no moving parts. This means that minimal maintenance is required (if at all).

A further advantage of using the laminate is that it does not rely on existing systems of the vehicle to operate. Therefore, this embodiment of the present invention can be readily fitted to an existing vehicle and readily comply with certification/safety checks.

In one embodiment, the laminate may fit under the brake pedal shoe which is normally a rubber sleeve that fits over the metal brake pedal.

In some embodiments the applicants provide a special designed brake pedal shoe which has a number of pressure projections which transfer the force from the driver's foot pressing on the shoe to the piezo-sensitive laminate.

The applicants have designed a piezo-sensitive laminate especially for use in the present invention. This design includes a grid structure enabling different sizes and shapes of laminate to be cut from a large sheet to accommodate the different sizes and shapes of brake pedals—and still have the right connections for the laminate to work.

Reference to the control unit may be made with reference to the appropriate electronics and electronic control mechanisms to sense the braking force sensor, and to perform the calculations and conversions necessary to provide the appropriate signal to the braking actuator mechanism.

The control unit may be referred to hereafter as the Electronic Control Unit (ECU).

Preferably, the ECU may include circuitry for system checking to assess whether the braking system is ready for normal operation.

The control unit may incorporate one or more ECU's mounted in either the towed or towing vehicle. The control unit electronics may be configured to operate as follows.

After installation of the present invention there may be an initialisation sequence which allows for the adjustment by the consumer. For example, the consumer may apply a light pressure to the brake pedal to indicate that this is the minimum amount of pressure required to initiate a braking action on the towed vehicle. The consumer may then apply a maximum force which indicates the 100% braking action required on the towing vehicles. The ECU may apply the relationship (say linear) between those two inputs so that proportional braking pressure can be calculated appropriately.

The force applied by the actuator mechanism in response to the ECU signal may be a percentage of the braking force sensed by the brake sensor on the towing vehicle.

The ECU may then read the load and relay the information to a towed vehicle mounted ECU.

A trailer-mounted ECU (herein after referred to as the auxiliary ECU ) may then operate the brake actuator mechanism.

Preferably the auxiliary ECU may then open a feed-valve to the cylinder and the actuator mechanism so that air pressure is introduced to the cylinder via a compressor to a pre-determined air pressure.

The predetermined air pressure will be gauged as is necessary to provide the necessary percentage of braking force to the towed vehicle relative to the braking pressure applied to the brake pedal of the towing vehicle

The ECU on the towing vehicle may preferably frequently poll the load on the brake pedal.

If the pressure on the brake pedal increases, the sequence aforementioned continues until equilibrium is achieved.

If the brake pedal pressure is released, the towing vehicle ECU relays the message to the auxiliary ECU to relieve any pressure in the brake cylinder through an exhaust valve.

This sequence may repeat every time a pressure is sensed on the brake pedal pressure pad.

The above operating configuration is given as an example only and should not be seen to be limiting in any way.

In other embodiments there may be provided a gain control. For example, it is envisaged that the towed vehicle may vary considerably in weight. For example if the towed vehicle is a boat trailer, it will be relatively light when the boat is off the trailer. and relatively heavy when the boat is on.

Therefore it may be desired to have a variable sensitivity of the reaction of the braking system and the towed vehicle and the towing vehicle. For example, a low gain or low sensitivity may be required when the trailer is unloaded compared to a higher gain required when the trailer is loaded.

This may be readily achieved for example with the movement of the dial or some other actuator.

In a separate aspect of the present invention a towed vehicle actuator mechanism may be configured to be operated independently for short periods of time.

These periods of time may be in situations where the towed vehicle is swaying or loses traction.

The present invention may be configured so that applying the towed vehicle brakes will settle an unstable or swaying vehicle.

In some embodiments there may be provided an activation means in the towing vehicle which will apply the towed vehicle brakes for only a pre-determined time and amount of force.

The activation means may be in the form of a panic switch. Preferably the activation means or panic switch is large enough and positioned that the user can readily access the same in emergencies, for example on the dashboard of a car near the steering wheel.

The activation means may also include visual and audible warning signals—for example, flashing lights and buzzers.

The system may be configured so that any force applied to the brake pedal by the actuator switch will be temporarily overridden.

The present invention may be configured so that if the auxiliary ECU becomes disconnected to the towing vehicle ECU, power will be cut to at least some if not all of the components in the towed vehicle.

This may be arranged in such a way as to apply the brakes on the towed vehicle to 100 per cent of the unit's capacity.

In other embodiments the present invention may include automatic sway detection (for example via a gyroscope) to detect towed vehicle oscillations. This automatic sway detection may automatically detect the swaying of the trailer above a certain frequency and apply the trailer brakes independently to that of the towing vehicle for a predetermined time period and force.

The present invention may provide for automatic towed vehicle weighing.

This may weigh the towed vehicle relative to its static unloaded state and apply a correction factor to the ECU for the required braking force. If the towed vehicle is empty, the maximum braking force may be set to a percentage of that of the loaded trailer.

For example only, if fifty percent braking is required (as determined by the pressure pad sensor and the ECU) and the trailer is empty, the force applied to the brakes will be fifty percent multiplied by the percentage of the maximum mass of the trailer.

The present invention may also include a visual display providing information on the status of the system.

The present invention may also provide for anti-lock braking.

According to another aspect of the present invention there is provide a method of applying a braking force to a towed vehicle proportional to a braking force applied at the towing vehicle, which includes a braking force sensor located on the towing vehicle, a control unit, and a braking actuator mechanism on the towed apparatus responsive to signals from the control unit, characterised by the steps of:

(i) sensing the force applied to the brake sensor,

(ii) converting the force to a pre-determined braking force to be applied to the towed vehicle,

(iii) signalling the brake actuator mechanism to apply the pre-determined proportional braking force.

The above method may be executed using apparatus as previously herein defined.

The pre-determined braking force may be preferably a percentage of the braking applied at the towing vehicle, which is determined by the signal from the brake sensor, and calculated by the control unit.

The present invention has a number of potential advantages. The present invention translate a pressure applied directly to the pad of the brake pedal under the operator's foot to sense brake application pressure. Therefore, the present invention overcomes potential problems associated with differing vehicles free-play in brake pedal movement, which could potentially result in incorrect braking force calculation and application.

The extensive electrical monitoring and control of the system, means that if a failure occurs anywhere in the system, the driver of the towing vehicle will be alerted of the problem.

If the towed vehicle becomes uncoupled, the present invention is configured to apply braking force to the trailer, reducing the risk of damage or accident to other property or persons as a result of the uncoupled trailer.

### BRIEF DESCRIPTION OF DRAWINGS

Further aspects of the present invention will become apparent from the following description which is given by way of example only and with reference to the accompanying drawings in which:

FIG. 1 shows a schematic view of one embodiment of the present invention pad,

FIG. 2 shows a view of a brake pedal construction in accordance with one embodiment of the present invention,

FIG. 3 schematic showing operation to pressure valves in accordance with one embodiment of the present invention.

### BEST MODES FOR CARRYING OUT THE INVENTION

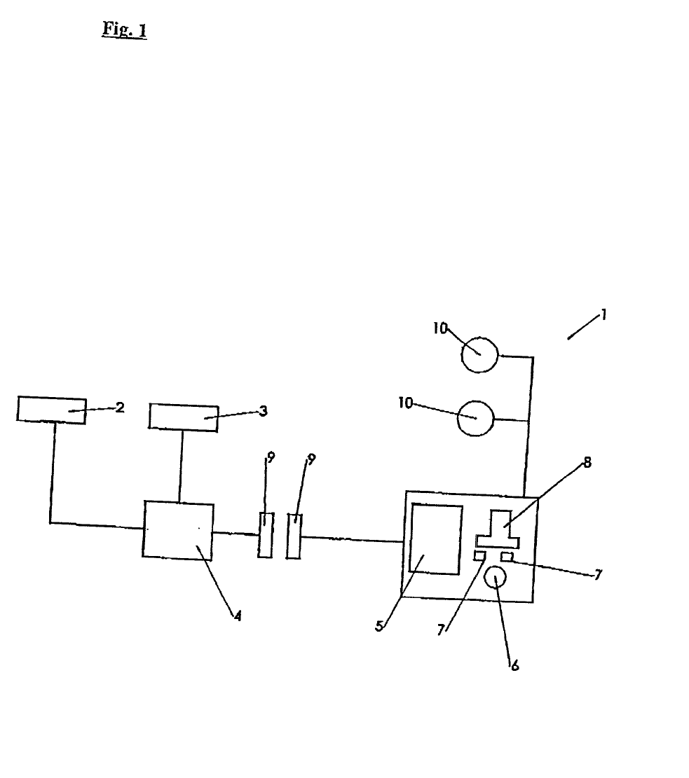

FIG. 1 shows one possible configuration of the present invention.

The braking system (1) according to the present invention may consist of two main components. These are the controller assembly and the actuator mechanism.

The controller circuitry consists of four components:

i) The pressure pad sensor (2) mounted to the towed vehicle brake pedal,

ii) an on-dash display module (3),

iii) a towing vehicle-mounted ECU (4) (Electronic Control Unit),

iv) a towed vehicle-mounted ECU (5).

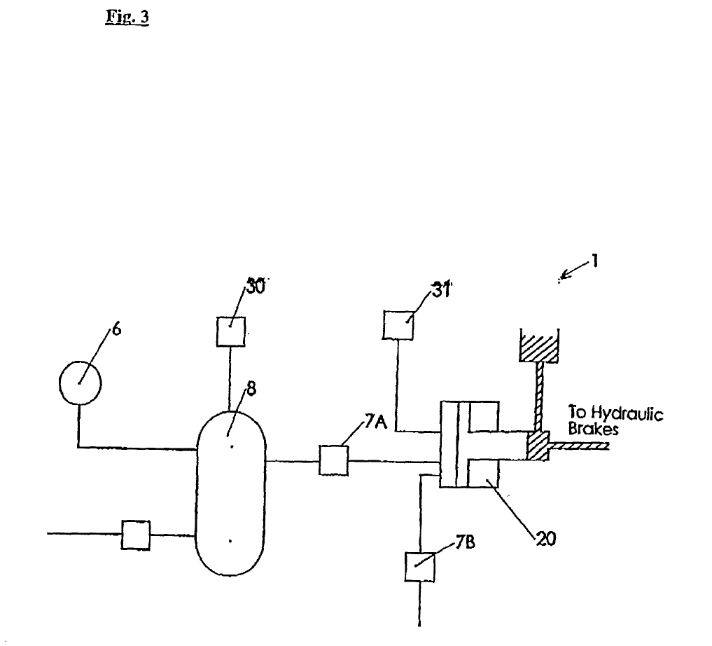

The actuator mechanism (shown in greater detail in FIG. 3). located on the towed vehicle consists of several components including a compressor (6), an accumulator (8). pneumatic valving (7a) and (7b), pneumatic piston assembly, (20) and a park brake assembly (in either mechanical or hydraulic form) (not shown).

The towed and towing vehicle electronics may be connected by pin plugs (9).

The towing vehicle ECU (4) functions as the main control unit of the system.

The ECU (4) may be configured to operate as follows.

When the system is initialised, the ECU (4) may turn on the compressor. While the compressor (6) is building up pressure, an on-dash display (3) may show the pressure in the accumulator. Once the compressor (6) has charged the accumulator (8) to an appropriate pressure (for example 100 PSI), the ECU (4) may receive a signal from one of two pressure transducers (30 and 31) in the accumulator mechanism to turn off the compressor.

The on-dash display (3) may indicate that all systems are normal and ready for braking application.

When the tow vehicle brakes are applied, the pressure pad sensor (2), which is located on the brake pedal pad, registers a load being applied to the brake pedal. This load is “read” by the tow vehicle ECU (“auxiliary ECU”), which then relays the information to the towed vehicle ECU, to open the feed valve (7a) to the cylinder. This is then translated to air pressure to be applied to the service brake assembly in the actuator

Once the pre-determined air pressure (measured by the second pressure transducer (31)) is reached, the auxiliary ECU closes the feed valve (7a).

The pressure on the brake pedal is polled continuously. If the pressure on the brake pedal increases, the sequence continues until equilibrium is achieved. When the brake pedal pressure is released, the tow vehicle ECU relays the message to the towed auxiliary ECU to relieve any pressure in the service brake cylinder through opening an exhaust valve (7b).

The above sequence may repeat every time pressure is sensed on the brake pedal pressure pad.

In some embodiments the trailer brakes (10) may also be operated independently for short periods of time.

For example in the situation of trailer swaying, applying the trailer brakes only will settle the vehicle.

A button may be provided on the dash display module, which will apply the trailer brakes for only a pre-determined time and amount of force.

If the button is pressed, any force applied to the brake pedal will be temporarily overridden with respect to the towed vehicle to a threshold level.

The present invention may also provide for self-monitoring and fault detection.

Preferably, the electronics may be configured so that if a fault is detected in the system, a warning light will illuminate on the dash display module and will sound an alarm if conditions dictate.

As an example, the parameters; monitored by the warning system may be as follows:

Compressor overtime (for example, nominally set to two minutes)

Compressor over current (nominally set to twenty amps)

Low air pressure (for example, light illuminating at approximately 70 PSI, with the buzzer sounding at 50 PSI, allowing enough air pressure for one emergency stop manoeuvre)

Trailer plug uncoupling.

Of course these parameters are examples only, or different parameters may be monitored by the fault detection circuitry.

The electronics may be configured so that if any warnings appear, the driver of the tow vehicle must complete physical cancellation of the light or buzzer, by pressing the panic button.

This will cancel the fault warning signal but will not remedy the problem with the braking system.

The fault warning may be configured to continue, so long as it is not being fixed.

The system may be configured so that when the unit is unplugged from the tow vehicle and a dust cap or other device is replaced, an electronic cancellation unit is provided which indicates to the tow vehicle ECU that the trailer is uncoupled and to deactivate the system.

However, once the electronic cancellation unit, which may be on a dust cap, the system according to the present invention will become activated and will look for the trailer mounted ECU. If one is not found, the warning sequence will resume.

The present invention may also he configured so that when the trailer is unplugged, power is cut to the trailer-mounted ECU. This results in power being cut to all of the components mounted on the trailer.

In preferred embodiments, the valves on the service brake cylinder may be arranged in such a way that when the valves lose power, the feed valve (7a) opens and the exhaust valve closes (7b).

The arrangement will be configured so that this will result in the service brake cylinder receiving all of the pressure inside the accumulator.

In the event that no warning lights illuminated when the brake cylinder receives all the pressure inside the accumulator, the brakes on the trailer will be applied to one hundred percent of the unit's capacity.

The above configuration provides for situations where the trailer becomes disconnected from the towing vehicle. The brakes will be applied automatically to the trailer.

The system may be configured so that in order to release the brakes the air pressure inside the accumulator mechanism must be released. This may he achieved by pressing a pressure release valve at the back of the unit which will evacuate all of the air pressure in the system. In order to reapply the brakes without the use of power, a parking brake lever may be provided.

The lever may be configured so that when it is moved from its rest position to the on position, it will apply the brakes.

If the system is in the discharged state, the initialising sequence may occur again.

The system may also include automatic trailer sway detection. The sway detection may include a module that automatically detects the swaying of the trailer above a certain frequency and applies the trailer brakes independently to that of the tow vehicle for a certain pre-determined time and force.

The present invention may also include automatic trailer weighing whereby the trailer is weighed relative to a static unloaded state. A correction factor may be determined and applied by the ECU for determining the braking force.

Antilock (ABS) braking may also be a feature of the present invention.

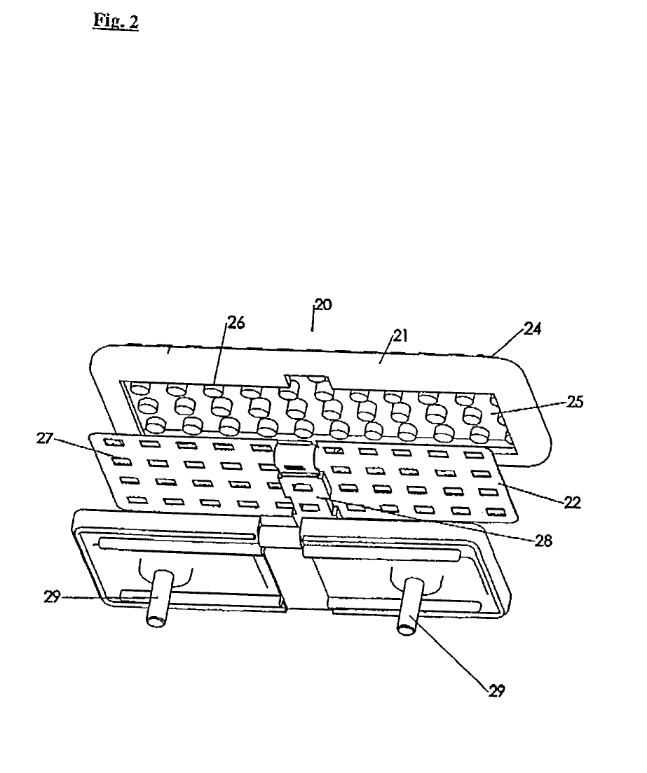

FIG. 2 illustrates an exploded view of a brake pedal configuration generally indicated by arrow 20 in accordance with one embodiment of the present invention.

The Brake pedal configuration (20) includes a brake pedal shoe (21), a piezo-electric laminate (22), and a backing plate (23).

The shoe (21) has an upper surface which is similar to that used in conventional brake shoes. The shoe (21) is also made from rubber so as to give a relatively high coefficient of friction.

The inner surface of the brake shoe (25) includes a number of pressure protrusions (26). The protrusions (26) help transfer the force applied to the outer surface (24) of the shoe (21) through to the laminate (22).

The laminate (22) has a number of piezo electric elements (27) set out in a grid. The elements (27) are electrically connected to each other in parallel which gives two major advantages.

One advantage is that the larger sheet of the laminate (22) can be readily cut to appropriate size to sit on a brake shoe without destroying the function of laminate (22).

Another advantage is that the elements (27) work out between them an average force being applied to the laminate (22).

Wires (28) carry the signal from the elements (27) to the ECU.

The backing plate (23) has two bolts (29) which enables the whole of the assembled unit (20) to readily connect onto existing brake pedal.

Aspects of the present invention have been described by way of example only and it should be appreciated that modifications and additions may be made thereto without departing from the scope of the appended claims.

What we claims is:

1. A system for effecting a braking force on a towed vehicle, the system including:
at least one braking sensor located on a towing vehicle,
a control unit for communication with a braking actuator mechanism located
on the apparatus towed by the towing vehicle,
the system characterised in that
the control unit can determine braking force sense by the braking sensor and signals a braking actuator mechanism to apply a braking force to a towed vehicle proportional to the force applied to the braking sensor as determined by the control unit.

2. A system as claimed in claim 1 which includes a park brake assembly.

3. A system as claimed in either claim 1 or claim 2 wherein the braking sensor is incorporated into a brake pedal pad.

4. A system as claimed in claim 3 wherein the braking sensor includes a piezo-sensitive laminate.

5. A system as claimed in any one of claims 1 to 4 which includes an auxiliary control unit mounted to the towed vehicle.

6. A system as claimed in any one of claims 1 to 5 characterised in that the control unit is frequently polls load on the brake pedal.

7. A system as claimed in any of the claims 1 to 6 which includes provision for the actuator mechanism to operate independently of the braking force sensed.

8. A system as claimed in claim 7 wherein the independent operation of the actuator mechanism is for a predetermined time and amount of force.

9. A system as claimed in any one of claims 1 to 8 configured so that if the auxiliary control unit on the towed vehicle is disconnected from the control unit on the towing vehicle, power is disconnected from at least some of the components on the towed vehicle.

10. A system as claimed in claim 9 so that upon disconnection of the towed vehicle from the towing vehicle the brakes on the towed vehicle will be operated to full capacity.

11. A system as claimed in any one of claims 1 to 10 which includes automatic sway detection to detect vehicle oscillation and apply the trailer brakes independently to that of the towing vehicle.

12. A system for effecting a braking force on a towed vehicle via an actuator mechanism characterised in that the actuator mechanism operates independently of any towing vehicle associated with the towed vehicle.

13. A system as claimed in claim 12 wherein the independent operation is for a predetermined time and amount of force.

14. A system is claimed in either claim 12 or claim 13 configured so that the auxiliary control unit on the towed vehicle is disconnected from the control unit on the towing vehicle, power is disconnected from at least the components on the towed vehicle.

15. A system as claimed in any one of claims 12 to 14 so that upon disconnection of the towed vehicle from the towing vehicle, the brakes on the towed vehicle will be operated to full capacity.

16. A system as claimed in any one of the previous claims which includes automatic sway detection to detect vehicle oscillation and apply the trailer brakes independently to that of the towing vehicle.

17. A piezo-sensitive laminate for use in a braking sensor.

18. A method of applying a braking force to the towed vehicle proportional to the braking force applied at the towing vehicle which includes a braking force sensor on a towing vehicle,
a control unit, and
a braking actuator on the towed apparatus responsive to signals from the control unit characterised by the steps of:
(a) sensing the force applied to the brake sensor,
(b) converting the force to a predetermined braking force to be applied to the towed vehicle,
(c) signalling the brake actuator mechanism to apply the predetermined proportional braking force.

19. A system substantially as herein described with reference to and as illustrated by the accompanying drawings.

20. A method substantially as herein described with reference to and as illustrated by the accompanying drawings.

21. A piezo-sensitive laminate substantially as herein and described with reference to and as illustrated by the accompanying drawings.
